(19) United States
(12) Patent Application Publication
(10) Pub. No.: US 2008/0043020 A1
(43) Pub. Date: Feb. 21, 2008

(54) USER INTERFACE FOR VIEWING STREET SIDE IMAGERY

(75) Inventors: Bradford J. Snow, Woodinville, WA (US); Chandrasekhar Thota, Redmond, WA (US); Rick D. Welsh, Duvall, WA (US); Jayaram N.M. Nanduri, Sammamish, WA (US); Eyal Ofek, Redmond, WA (US); Stephen L. Lawler, Redmond, WA (US); Sean S. Rowe, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/465,500

(22) Filed: Aug. 18, 2006

(51) Int. Cl. G06T 15/20

(52) U.S. Cl. 345/427

(57) ABSTRACT

The claimed subject matter provides a system and/or a method that facilitates providing an immerse view having at least one portion related to aerial view data and a disparate portion related to a first-person ground-level view. A receiver component can receive at least one of geographic data and an input. An interface component can generate an immersed view based on at least one of the geographic data and the input, the immersed view includes a first portion of aerial data and a second portion of a first-person perspective view corresponding to a location related to the aerial data.

### BACKGROUND

Electronic storage mechanisms have enabled accumulation of massive amounts of data. For instance, data that previously required volumes of books to record data can now be stored electronically without expense of printing paper and with a fraction of space needed for storage of paper. In one particular example, deeds and mortgages that were previously recorded in volumes of paper can now be stored electronically. Moreover, advances in sensors and other electronic mechanisms now allow massive amounts of data to be collected in real-time. For instance, GPS systems track a location of a device with a GPS receiver. Electronic storage devices connected thereto can then be employed to retain locations associated with such receiver. Various other sensors are also associated with similar sensing and data retention capabilities.

Today's computers also allow utilization of data to generate various maps (e.g., an orthographic projection map, a road map, a physical map, a political map, a relief map, a topographical map, etc.), displaying various data (e.g., perspective of map, type of map, detail-level of map, etc.) based at least in part upon the user input. For instance, Internet mapping applications allow a user to type in an address or address(es), and upon triggering a mapping application, a map relating to an entered address and/or between addresses is displayed to a user together with directions associated with such map. These maps typically allow minor manipulations/adjustments such as zoom out, zoom in, topology settings, road hierarchy display on the map, boundaries (e.g. city, county, state, country, etc.), rivers, buildings, and the like.

However, regardless of the type of map employed and/or the manipulations/adjustments associated therewith, there are certain trade-offs between what information will be provided to the viewer versus what information will be omitted. Often these trade-offs are inherent in the map's construction parameters. For example, whereas a physical map may be more visually appealing, a road map is more useful in assisting travel from one point to another over common routes. Sometimes, map types can be combined such as a road map that also depicts land formation, structures, etc. Yet, the combination of information should be directed to the desire of the user and/or target user. For instance, when the purpose of the map is to assist travel, certain other information, such as political information may not be of much use to a particular user traveling from location A to location B. Thus, incorporating this information may detract from utility of the map. Accordingly, an ideal map is one that provides the viewer with useful information, but not so much that extraneous information detracts from the experience.

Another way of depicting a certain location that is altogether distinct from orthographic projection maps is by way of implementing a first-person perspective. Often this type of view is from a ground level, typically represented in the form of a photograph, drawing, or some other image of a feature as it is seen in the first-person. First-person perspective images, such as “street-side” images, can provide many local details about a particular feature (e.g. a statue, a house, a garden, or the like) that conventionally do not appear in orthographic projection maps. As such, street-side images can be very useful in determining/exploring a location based upon a particular point-of-view because a user can be directly observing a corporeal feature (e.g., a statue) that is depicted in the image. In that case, the user might readily recognize that the corporeal feature is the same as that depicted in the image, whereas with an orthographic projection map, the user might only see, e.g. a small circle that represents the statute that is otherwise indistinguishable from many other statutes similarly represented by small circles or even no symbol that designates the statute based on the orthographic projection map does not include such information.

However, while street-side maps are very effective at supplying local detail information such as color, shape, size, etc., they do not readily convey the global relationships between various features resident in orthographic projection maps, such as relationships between distance, direction, orientation, etc. Accordingly, current approaches to street-side imagery/mapping have many limitations. For example, conventional applications for street-side mapping employ an orthographic projection map to provide access to a specific location then separately display first-person images at that location. Yet, conventional street-side maps tend to confuse and disorient users, while also providing poor interfaces that do not provide a rich, real-world feeling while exploring and/or ascertaining driving directions.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate providing an immerse view having at least one portion related to aerial view data and a disparate portion related to a first-person ground-level view. An interface component can generate an immersed view that can provide a first portion with aerial data and a corresponding second portion that displays first-person perspective data based on a location on the aerial data. The interface component can receive at least one of a data and an input via a receiver component. The data can be any suitable geographic data such as, but not limited to, 2-dimensional geographic data, 3-dimensional geographic data, aerial data, street-side imagery, video associated with geography, video data, ground-level imagery, satellite data, digital data, images related to a geographic location, and any suitable data related to maps, geography, and/or outer space. Furthermore, the input can be, but is not limited to being, a starting address, a location, an address, a zip code, a landmark, a building, an intersection, a business, and any suitable data related to a location and/or point on a map of any area. Moreover, it is to be appreciated that the input and/or geographic data can be a default setting and/or default data pre-established upon startup.

In accordance with one aspect of the claimed subject matter, the immersed view can include an orientation icon that can indicate a particular location associated with the aerial data to allow the second portion of the immersed view to display a corresponding first-person perspective view. The orientation icon can be any suitable graphic and/or icon that can indicate at least one of a location overlaying aerial data and a direction associated therewith. The orientation icon can further include a skin, wherein the skin provides an interior appearance wrapped around at least one of the first section, the second section, and the third section of the second portion, the skin corresponds to at least an interior aspect of the representative orientation icon.

In accordance with another aspect of the claimed subject matter, the immersed view can employ a snapping feature that maintains a pre-established course upon the aerial data during a movement of the orientation icon. Thus, a particular route can be illustrated within the immersed view such that a video-like experience is presented while updating the aerial data in the first portion and the first-person perspective data within the second portion in real-time and dynamically. In other aspects of the claimed subject matter, methods are provided that facilitate providing geographic data utilizing first-person street-side views based at least in part upon a specific location associated with aerial data.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates providing an immerse view having at least one portion related to aerial view data and a disparate portion related to a first-person ground-level view.

FIG. 2 illustrates a block diagram of an exemplary system that facilitates providing geographic data utilizing first-person street-side views based at least in part upon a specific location associated with aerial data.

FIG. 3 illustrates a block diagram of an exemplary system that facilitates presenting geographic data to an application programmable interface (API) that includes a first-person street-side view that is associated with aerial data.

FIG. 4 illustrates a block diagram of a generic user interface that facilitates implementing an immerse view of geographic data having a first portion related to aerial data and a second portion related to a first-person street-side view based on a ground-level orientation paradigm.

FIG. 5 illustrates a screen shot of an exemplary user interface that facilitates providing aerial data and first-person perspective, street-side views based upon a vehicle paradigm.

FIG. 6 illustrates a block diagram of an exemplary system that facilitates providing an immerse view having at least one portion related to aerial view data and a disparate portion related to a first-person street-side view.

FIG. 7 illustrates a screen shot of an exemplary user interface that facilitates employing aerial data and first-person perspective data in a user-friendly and organized manner utilizing a vehicle paradigm.

FIG. 8 illustrates a screen shot of an exemplary user interface that facilitates providing aerial data and first-person street-side data in a user-friendly and organized manner utilizing a vehicle paradigm.

FIG. 9 illustrates a screen shot of an exemplary user interface that facilitates displaying geographic data based on a particular first-person street-side view associated with aerial data.

FIG. 10 illustrates a screen shot of an exemplary user interface that facilitates depicting geographic data utilizing aerial data and at least one first-person perspective street-side view associated therewith.

FIG. 11 illustrates a screen shot of an exemplary user interface that facilitates providing a panoramic view based at least in part on a ground-level orientation paradigm.

FIG. 12 illustrates an exemplary user interface that facilitates providing geographic data while indicating particular first-person street-side data is unavailable.

FIG. 13 illustrates an exemplary user interface that facilitates providing a particular orientation icon for presenting aerial data and a first-person street-side view.

FIG. 14 illustrates an exemplary user interface that facilitates providing a particular orientation icon for presenting aerial data and a first-person street-side view.

FIG. 15 illustrates an exemplary user interface that facilitates providing a particular orientation icon for presenting aerial data and a first-person street-side view.

FIG. 16 illustrates an exemplary methodology for providing an immerse view having at least one portion related to aerial view data and a disparate portion related to a first-person street-side view.

FIG. 17 illustrates an exemplary methodology that facilitates implementing an immerse view of geographic data having a first portion related to aerial data and a second portion related to a first-person street-side view based on a ground-level orientation paradigm.

FIG. 18 illustrates an exemplary networking environment, wherein the novel aspects of the claimed subject matter can be employed.

FIG. 19 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “device,” “API,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

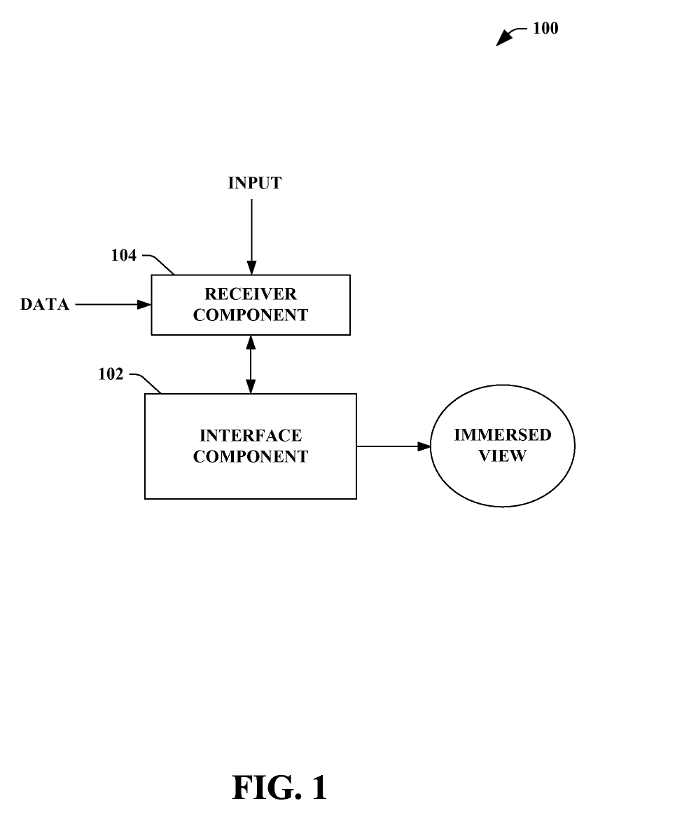

Now turning to the figures, FIG. 1 illustrates a system 100 that facilitates providing an immerse view having at least one portion related to aerial view data and a disparate portion related to a first-person ground-level view. The system 100 can include an interface component 102 that can receive at least one of a data and an input via a receiver component 104 to create an immersed view, wherein the immersed view includes map data (e.g., any suitable data related to a map such as, but not limited to, aerial data) and at least a portion of street-side data from a first-person and/or third-person perspective based upon a specific location related to the data. The immersed view can be generated by the interface component 102, transmitted to a device by the interface component 102, and/or any combination thereof It is to be appreciated that the data can be any suitable geographic data such as, but not limited to, 2-dimensional geographic data, 3-dimensional geographic data, aerial data, street-side imagery (e.g., first-person perspective and/or third-person perspective), video associated with geography, video data, ground-level imagery, planetary data, planetary ground-level imagery, satellite data, digital data, images related to a geographic location, orthographic map data, scenery data, map data, street map data, hybrid data related to geography data (e.g., road data and/or aerial imagery), and any suitable data related to maps, geography, and/or outer space. In addition, it is to be appreciated that the receiver component 104 can receive any input associated with a user, machine, computer, processor, and the like. For example, the input can be, but is not limited to being, a starting address, a starting point, a location, an address, a zip code, a state, a country, a county, a landmark, a building, an intersection, a business, a longitude, a latitude, a global positioning (GPS) coordinate, a user input (e.g., a mouse click, an input device signal, a touch-screen input, a keyboard input, etc.), and any suitable data related to a location and/or point on a map of any area (e.g., land, water, outer space, air, solar systems, etc.). Moreover, it is to be appreciated that the input and/or geographic data can be a default setting and/or default data pre-established upon startup.

For instance, the immersed view can provide geographic data for presentation in a manner such that orientation is maintained between the aerial data (e.g., map data) and the ground-level perspective. Moreover, such presentation of data is user friendly and comprehendible based at least in part upon employing a ground-level orientation paradigm. Thus, the ground-level perspective can be dependent upon a location and/or starting point associated with the aerial data. For example, an orientation icon can be utilized to designate a location related to the aerial data (e.g., aerial map), where such orientation icon can be the basis of providing the perspective for the ground-level view. In other words, an orientation icon can be pointing in the north direction on the aerial data, while the ground-level view can be a first-person view of street-side imagery looking in the north direction. As discussed below, the orientation icon can be any suitable display icon such as, but not limited to, an automobile, a bicycle, a person, a graphic, an arrow, an all-terrain vehicle, a motorcycle, a van, a truck, a boat, a ship, a space ship, a bus, a plane, a jet, a unicycle, a skateboard, a scooter, a self-balancing human transporter, and any suitable orientation icon that can provide a direction and/or orientation associated with aerial data.

In one example, the receiver component 104 can receive aerial data related to a city and a starting location (e.g. default and/or input), such that the interface component 102 can generate at least two portions. The first portion can relate to map data (e.g., such as aerial data and/or any suitable data related to a map), such as a satellite aerial view of the city including an orientation icon, wherein the orientation icon can indicate the starting location. The second portion can be a ground-level view of street-side imagery with a first-person and/or third-person perspective associated with the orientation icon. Thus, if the first portion contains the orientation icon on an aerial map at a starting location on the intersection of Main St. and W. 47^{th} St., facing east, the second portion can display a first-person view of street-side imagery facing east on the intersection of Main St. and W. 47^{th} St. at and/or near ground level (e.g., eye-level for a typical user). By utilizing this ground-level orientation paradigm, a user can easily receive first-perspective data and/or third-person perspective data based on map data continuously without disorientation based on the easy to comprehend ground-level orientation paradigm.

In another example, map data (e.g. aerial data and/or any suitable data related to a map) associated with a planetary surface, such as Mars can be utilized by the interface component 102. A user can then utilize the orientation icon to maneuver about the surface of the planet Mars based on the location of the orientation icon and a particular direction associated therewith. In other words, the interface component 102 can provide a first portion indicating a location and direction (e.g., utilizing the orientation icon), while the second portion can provide a first-person and/or third-person, ground-level view of imagery. It is to be appreciated that as the orientation icon is moved about the aerial data, the first-person and/or third-person, ground-level view corresponds therewith and can be continuously updated.

In accordance with another aspect of the claimed subject matter, the interface component 102 can employ maintaining a ground-level direction and/or route associated with at least a portion of a road, a highway, a street, a path, course of direction, etc. In other words, the interface component 102 can utilize a road/route snapping feature, wherein regardless of the input for a location, the orientation icon will maintain a course on a road, highway, street, path, etc. while still providing first-person and/or third-person ground-level imagery based on such snapped/designated course of the orientation icon. For instance, the orientation icon can be snapped and/or designated to follow a particular course of directions such that regardless of input, the orientation will only follow designated roads, paths, streets, highways, and the like.

Moreover, the system 100 can include any suitable and/or necessary presentation component (not shown and discussed infra), which provides various adapters, connectors, channels, communication paths, etc. to integrate the interface component 102 into virtually any operating and/or database system(s). In addition, the presentation component can provide various adapters, connectors, channels, communication paths, etc., that provide for interaction with the interface component 102, receiver component 104, the immersed view, and any other device, user, and/or component associated with the system 100.

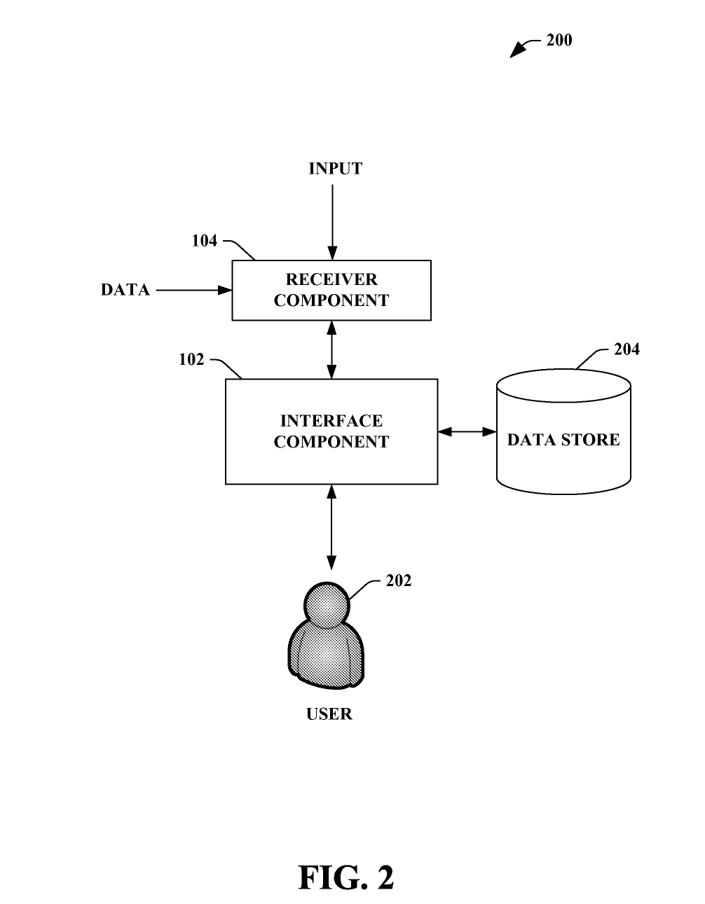

FIG. 2 illustrates a system 200 that facilitates providing geographic data utilizing first-person and/or third-person street-side views based at least in part upon a specific location associated with map data (e.g. aerial data and/or any suitable data associated with a map). The interface component 102 can receive data via the receiver component 104 and generate a user interface that provides map data and first-person and/or third-person, ground-level views to a user 202. For instance, the map data (e.g., aerial data and/or any suitable data related to a map) can be satellite images of a top-view of an area, wherein the user 202 can manipulate the location of an orientation icon within the top-view of the area. Based on the orientation icon location, a first-person perspective view and/or a third-person perspective view can be presented in the form of street-side imagery from ground-level. In other words, the interface component 102 can generate the map data (e.g., aerial data and/or any data related to a map) and the first-person perspective and/or a third-person perspective in accordance with the ground-level orientation paradigm as well as present such graphics to the user 202. Moreover, it is to be appreciated that the interface component 102 can further receive any input from the user 202 utilizing an input device such as, but not limited to, a keyboard, a mouse, a touch-screen, a joystick, a touchpad, a numeric coordinate, a voice command, etc.

The system 200 can further include a data store 204 that can include any suitable data related to the system 200. For example, the data store 204 can include any suitable geographic data such as, but not limited to, 2-dimensional geographic data, 3-dimensional geographic data, aerial data, street-side imagery (e.g., first-person perspective and/or third-person perspective), ground-level imagery, planetary data, planetary ground-level imagery, satellite data, digital data, images related to a geographic location, orthographic map data, scenery data, map data, street map data, hybrid data related to geography data (e.g., road data and/or aerial imagery), topology photography, geographic photography, user settings, user preference, configurations, graphics, templates, orientation icons, orientation icon skins, data related to road/route snapping features and any suitable data related to maps, geography, and/or outer space.

It is to be appreciated that the data store 204 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 204 of the subject systems and methods is intended to comprise, without being limited to, these and any other suitable types of memory. In addition, it is to be appreciated that the data store 204 can be a server, a database, a hard drive, and the like.

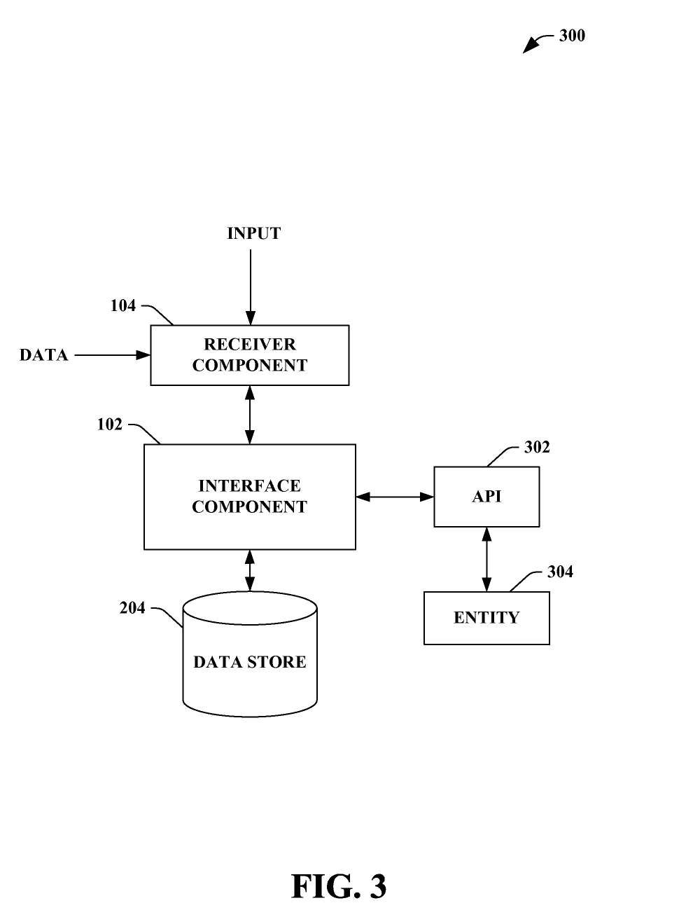

FIG. 3 illustrates a system 300 that facilitates presenting geographic data to an application programmable interface (API) that includes a first-person street-side view that is associated with aerial data. The system 300 can include the interface component 102 that can provide data associated with a first portion of a user interface and a second portion of the user interface, wherein the first portion includes map data (e.g., aerial data and/or any suitable data related to a map) with an orientation icon and the second portion includes ground-level imagery with a first-person perspective and/or a third-person perspective based on the location/direction of the orientation icon. For example, the data store 204 can include aerial data associated with a body of water and sea-level, first-person imagery corresponding to such aerial data. Thus, the aerial data and the sea-level first-person imagery can provide a user with a real-world interaction such that any location selected (e.g., utilizing an orientation icon with, for instance, a boat skin) upon the aerial data can correspond to at least one first-person view and/or perspective.

The interface component 102 can provide data related to the first portion and second portion to an application programmable interface (API) 302. In other words, the interface component 102 can create and/or generate an immersed view including the first portion and the second portion for employment in a disparate environment, system, device, network, and the like. For example, the receiver component 104 can receive data and/or an input across a first machine boundary, while the interface component 102 can create and/or generate the immersed view and transmit such data to the API 302 across a second machine boundary. The API 302 can then receive such immersed view and provide any manipulations, configurations, and/or adaptations to allow such immersed view to be displayed on an entity 304. It is to be appreciated that the entity can be a device, a PC, a pocket PC, a tablet PC, a website, the Internet, a mobile communications device, a smartphone, a portable digital assistant (PDA), a hard disk, an email, a document, a component, a portion of software, an application, a server, a network, a TV, a monitor, a laptop, any suitable entity capable of displaying data, etc.

In one example, a user can utilize the Internet to provide a starting address and an ending address associated with a particular portion of map data (e.g., aerial data and/or any suitable data related to a map). The interface component 102 can create the immersed view based on the particular starting and ending addresses, wherein the API component 302 can format such immersed view for the particular entity 304 to display (e.g. a browser, a monitor, etc.). Thus, the system 300 can provide the immersed view to any entity that is capable of displaying data to facilitate providing directions, exploration, and the like in relation to geographic data.

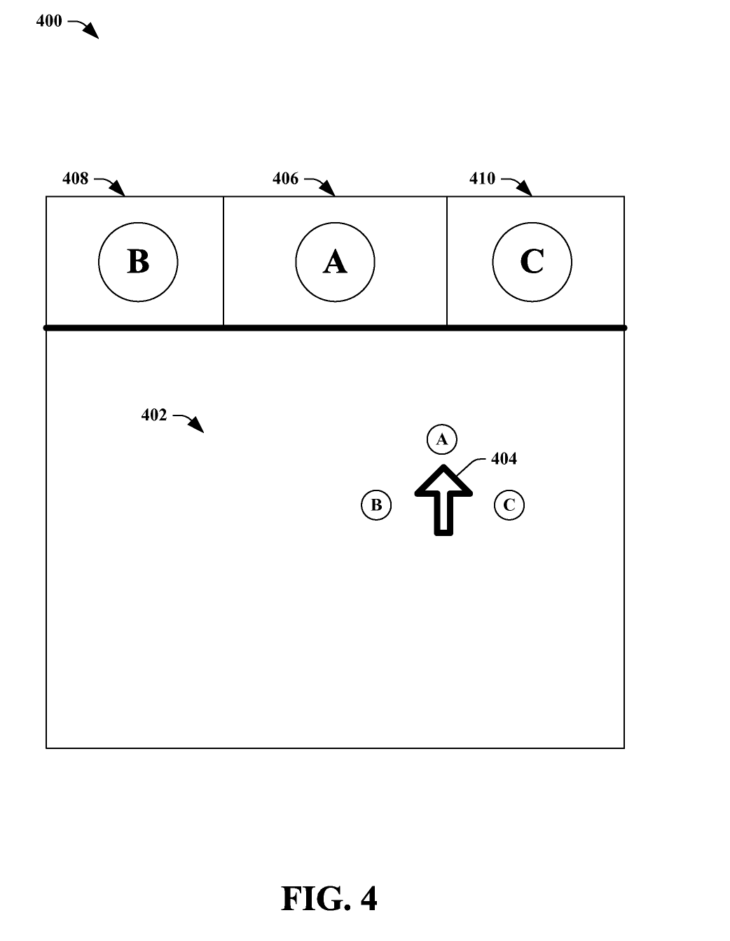

FIG. 4 illustrates a generic user interface 400 that facilitates implementing an immerse view of geographic data having a first portion related to map data (e.g., aerial data and/or any suitable map data) and a second portion related to a first-person and/or third-person street-side view based on a ground-level orientation paradigm. The generic user interface 400 can illustrate an immersed view which can include a first portion 402 illustrating map data (e.g., aerial data and/or any suitable data related to a map) in accordance with a particular location and/or geography. It is to be appreciated that the first portion 402 display is not so limited to the size of the first portion since a scrolling/panning technique can be employed to navigate through the map data. An orientation icon 404 can be utilized to indicate a specific destination/location on the map data (e.g. aerial data and/or any suitable data related to a map), wherein such orientation icon 404 can indicate at least one direction. As depicted in FIG. 4, the orientation icon depicts three (3) directions, A, B, and C, where A designates north, B designates west, and C designates east. It is to be appreciated that any suitable number of directions can be indicated by the orientation icon 404 to allow any suitable number of perspectives displayed (discussed infra).

Corresponding to the orientation icon 404 can be at least one first-person view and/or third-person view of ground-level imagery in a perspective consistent with a ground-level orientation paradigm. It is to be appreciated that although the term “ground-level” is utilized, the claimed subject matter covers any variation thereof such as, sea-level, planet-level, ocean-floor level, a designated height in the air, a particular coordinate, etc. A second portion (e.g., divided into three sections) can include the respective and corresponding first-person view and/or third-person view of ground-level imagery. Thus, a first section 406 can illustrate the direction A to display first-person and/or third-person perspective ground-level imagery respective to the position of the orientation icon 404 (e.g., the north direction); a second section 408 can illustrate the direction B to display first-person and/or third-person perspective ground-level imagery respective to the position of the orientation icon 404 (e.g., the west direction); and a third section 410 can illustrate the direction C to display first-person and/or third-person perspective ground-level imagery respective to the position of the orientation icon 404 (e.g., the east direction).

Although the generic user interface 400 illustrates three (3) first-person and/or third-person perspective views of ground-level imagery, it is to be appreciated that the user interface 400 can illustrate any suitable number of first-person and/or third-person views corresponding to the location of the orientation icon related to the map data (e.g., aerial data and/or any suitable data related to a map). However, it is to be stated that to increase user friendliness and decrease user disorientation, three (3) views is an ideal number to mirror a user's real-life perspective. For instance, while walking, a user tends to utilize a straight-ahead view, and corresponding peripheral vision (e.g., left and right side views). Thus, the generic user interface 400 mimics the real-life perspective and views of a typical human being.

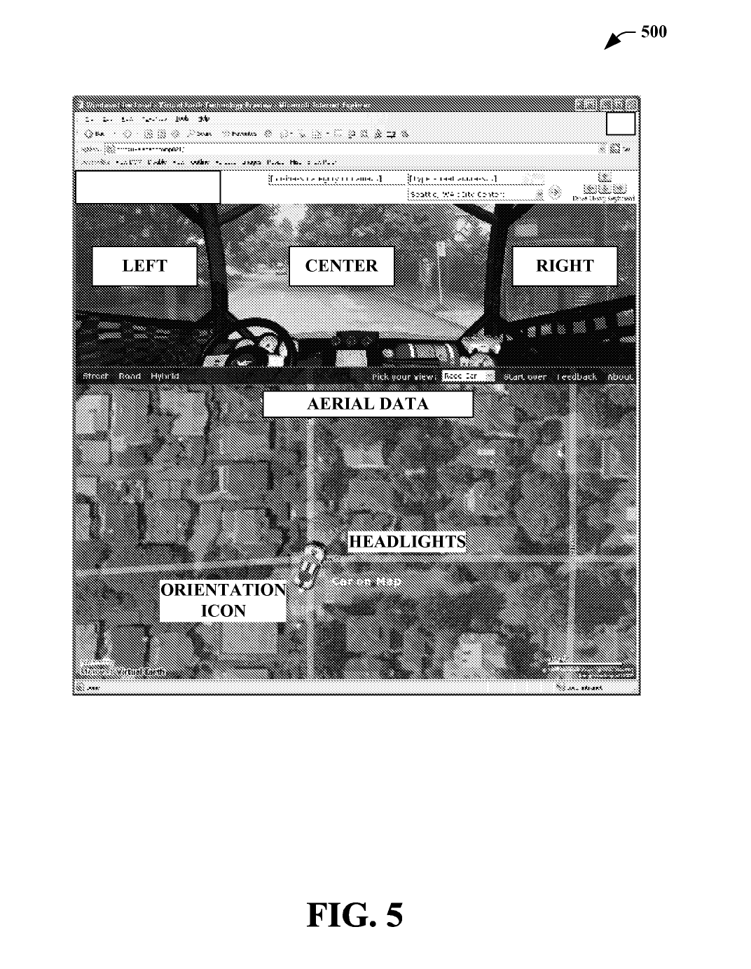

FIG. 5 illustrates a screen shot 500 that facilitates providing aerial data and first-person perspective, street-side views based upon a vehicle paradigm. The screen shot 500 depicts an exemplary immersed view with a first portion including an orientation icon (e.g., a car with headlights to indicate direction facing) overlaying aerial data. In a second portion of the immersed view, three (3) sections are utilized to display the particular views that correspond to the orientation icon (e.g., indicated by center, left, and right). Furthermore, the second portion can employ a “skin” that corresponds and relates to the orientation icon. In this particular example, the orientation icon is a car icon and the skin is a graphical representation of the inside of a car (e.g., steering wheel, gauges, dashboard, etc.). The headlights relating to the car icon can signify the orientation of the center, left, and right views such that the straight-ahead corresponds to straight ahead of the car icon, left is left of the car icon, and right is right of the car icon. Based on the use of the car icon as the basis for orientation, it is to be appreciated that the screen shot 500 utilizes a car orientation paradigm.

It is to be appreciated that the screen shot 500 is solely for exemplary purposes and the claimed subject matter is not so limited. For example, the orientation icon can be any suitable icon that can depict a particular location and at least one direction on the aerial data. As stated earlier, the orientation icon can be, but is not limited to being, a an automobile, a bicycle, a person, a graphic, an arrow, an all-terrain vehicle, a motorcycle, a van, a truck, a boat, a ship, a space ship, a bus, a plane, a jet, a unicycle, a skateboard, a scooter, a self-balancing human transporter, etc. Moreover, the aerial data depicted is hybrid data (satellite imagery with road/street/highway/path graphic overlay) but can be any suitable aerial data such as, but not limited to, aerial graphics, any suitable data related to a map, 2-D graphics, 2-D satellite imagery (e.g., or any suitable photography to depict an aerial view), 3-D graphics, 3-D satellite imagery (e.g., or any suitable photography to depict an aerial view), geographic data, etc. Furthermore, the skin can be any suitable skin that relates to the particular orientation icon. For example, if the orientation icon is a jet, the skin can replicate the cockpit of a jet.

It is to be appreciated that although the user interface depicts aerial data associated with a first-person view from an automobile, it is to be appreciated that the claimed subject matter is not so limited. In one particular example, the aerial data can be related to the planet Earth. The orientation icon can be a plane, where the first-person views can correspond to a particular location associated with the orientation icon such that the views simulate the views in the plane as if traveling over such location.

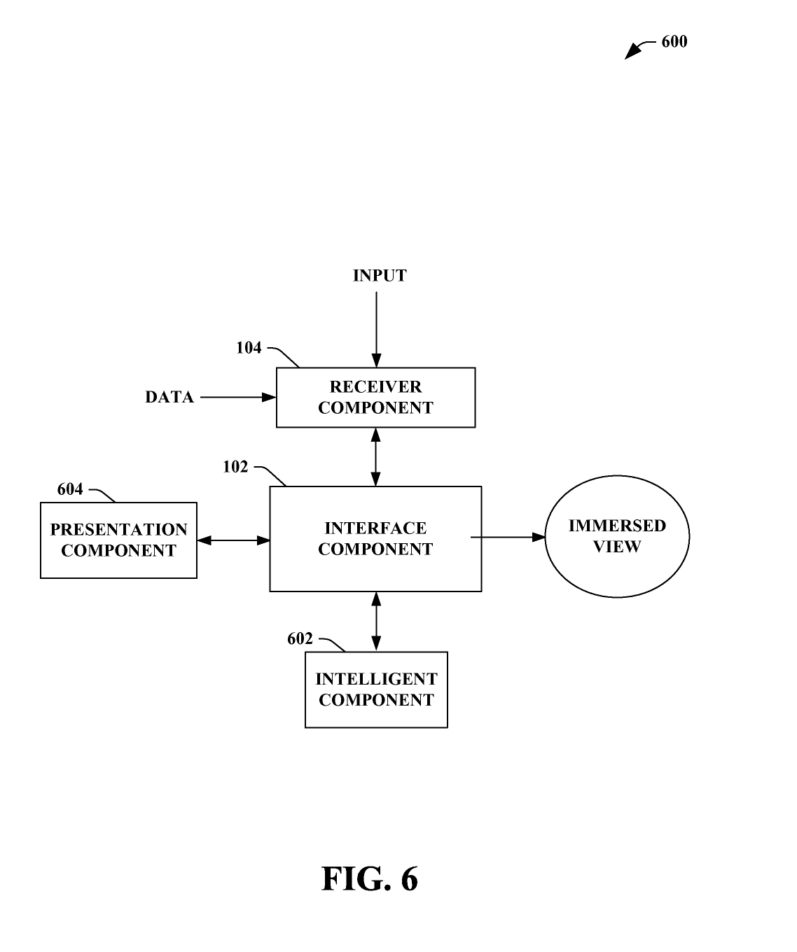

FIG. 6 illustrates a system 600 that employs intelligence to facilitate providing an immerse view having at least one portion related to map data (e.g. aerial view data and/or any suitable data related to a map) and a disparate portion related to a first-person and/or a third-person street-side view. The system 600 can include the interface component 102, the receiver component 104, and an immersed view. It is to be appreciated that the interface component 102, the receiver component 104, and the immersed view can be substantially similar to respective components, and views described in previous figures. The system 600 further includes an intelligent component 602. The intelligent component 602 can be utilized by the interface component 102 to facilitate creating an immersed view that illustrates map data (e.g., aerial data and/or any suitable data related to map) and at least one first-person and/or third-person view correlating to a location on the aerial view within the bounds of a ground-level orientation paradigm. For example, the intelligent component 602 can infer directions, starting locations, ending locations, orientation icons, first-person views, third-person views, user preferences, settings, user profiles, optimized aerial data and/or first-person and/or third-person imagery, orientation icon, skin data, optimized routes between at least two locations, etc.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The interface component 102 can further utilize a presentation component 604 that provides various types of user interfaces to facilitate interaction between a user and any component coupled to the interface component 102. As depicted, the presentation component 604 is a separate entity that can be utilized with the interface component 102. However, it is to be appreciated that the presentation component 604 and/or similar view components can be incorporated into the interface component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the interface component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

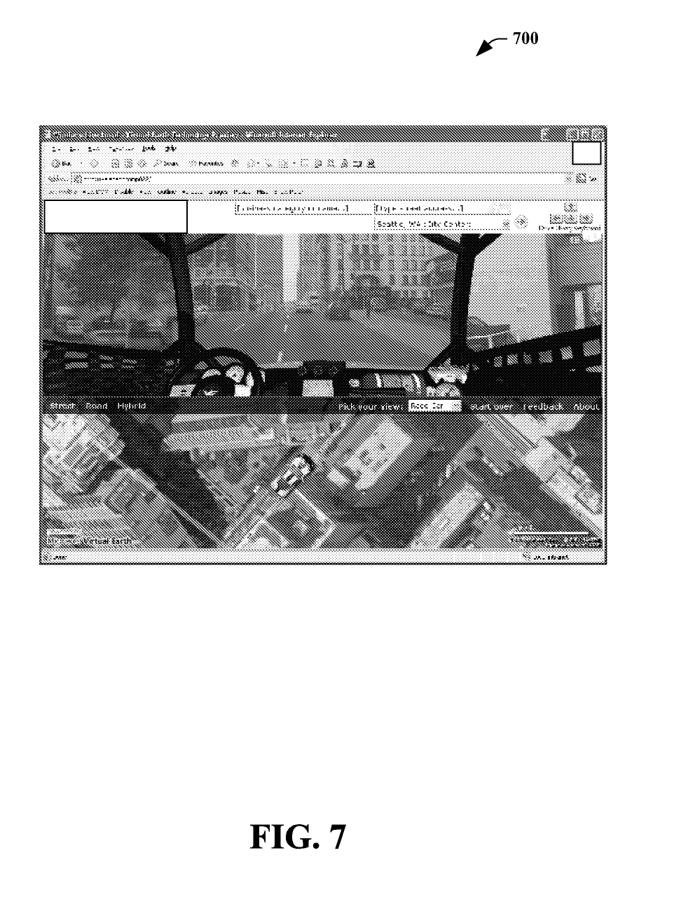

Referring to FIGS. 7-15, user interfaces in accordance with various aspects of the claims subject matter are illustrated. It is to be appreciated and understood that the user interfaces are exemplary configuration and that various subtleties and/or nuances can be employed and/or implemented; yet such minor manipulations and/or differences are to be considered within the scope and/or coverage of the subject innovation.

FIG. 7 illustrates a screen shot 700 that facilitates employing aerial data and first-person perspective data in a user-friendly and organized manner utilizing a vehicle paradigm. The screen shot 700 illustrates an immersed view having a first portion (e.g. depicting aerial data) and a second portion (e.g., depicting first-person views based on an orientation icon location). Street side imagery can be images taken along a portion of the streets and roads of a given area. Due to the large number of images, there is a great importance for easy browsing and clear display of the images such as the screen shot 700 of the immersed view which is an intuitive mental mapping between the aerial data and at least one first-person view. It is to be appreciated that the following explanation refers to the implementation of the orientation icon being an automobile. However, as described supra, it is to be understood that the subject innovation is not so limited and the orientation icon, skins, and/or first-person perspectives can be in a plurality of paradigms (e.g. boat, walking, jet, submarine, hang-glider, etc.).

The claimed subject matter employs an intuitive user interface (e.g., an immersed view) for street-side imagery browsing centered around a ground-level orientation paradigm. By depicting street side imagery through the view of being inside a vehicle, the users are presented with a familiar context such as driving along a road and looking out the windows. In other words, the user instantly understands what they are seeing without any further explanation since the experience mimics that of riding in a vehicle and exploring the surrounding scenery. Along with the overall vehicle concept, there are various details of the immersed view, illustrated as an overview with screen shot 700.

The immersed view can include a mock vehicle interior with a left side window, center windshield, and right side window. The view displayed in the map is ascertained by the vehicle icon's position and orientation on the map relative to the road it is placed on. The vehicle can snap to 90 degrees that are parallel or orthogonal to the road. The center windshield can shows imagery from the view the nose of the vehicle to which it is pointing towards. For instance, if the vehicle is oriented along the road, a front view of the road in the direction the car is pointing can be displayed.

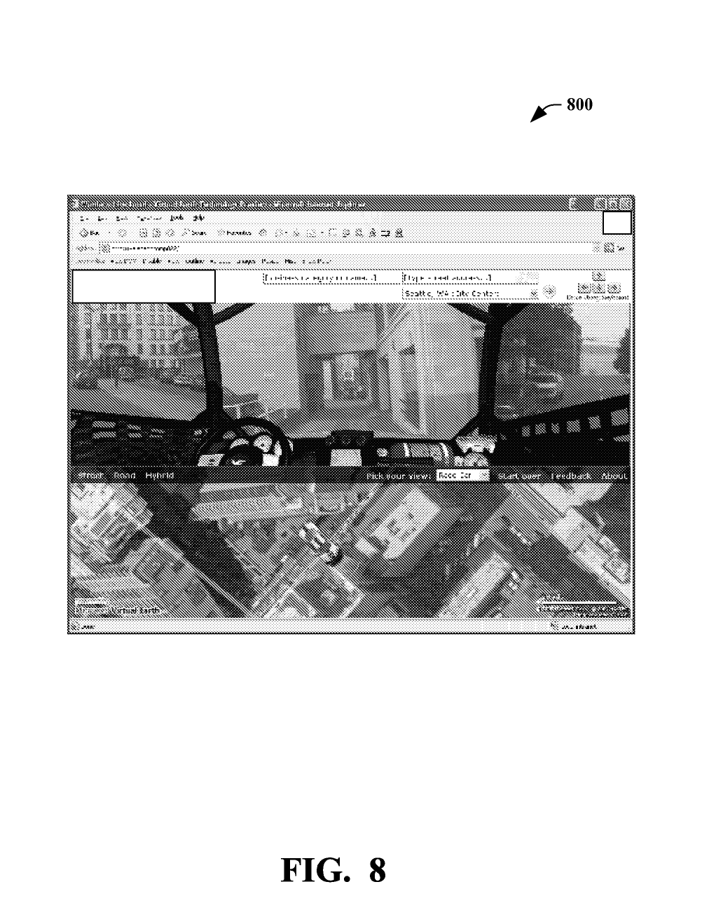

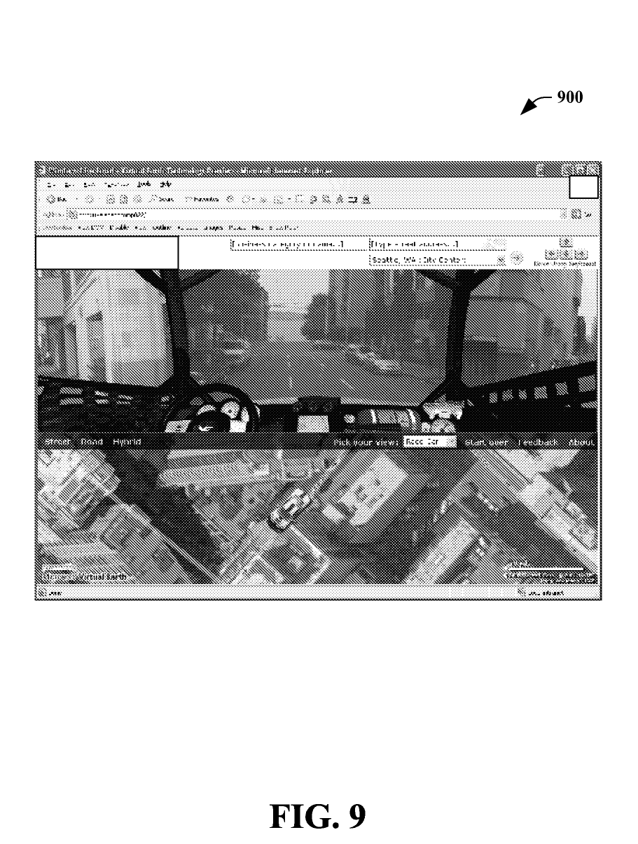

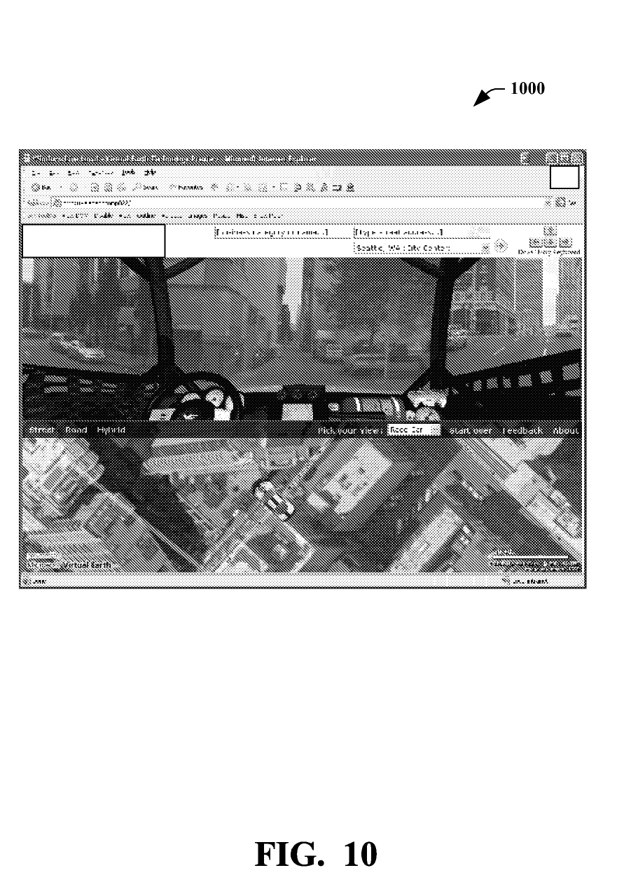

Turning quickly to FIGS. 8-11, four disparate views associated with a particular location on the aerial data (e.g., overhead map) are illustrated. Thus, a screen shot 800 in FIG. 8 illustrates the vehicle turned 90 degrees in relation to the position in FIG. 7, while providing first-person views for such direction. FIG. 9 illustrates a screen shot 900 that illustrates the vehicle turned 90 degrees in relation to the position in FIG. 8, while providing first-person views for such direction. FIG. 10 illustrates a screen shot 1000 that illustrates the vehicle turned 90 degrees in relation to the position in FIG. 9, while providing first person-views for such direction.

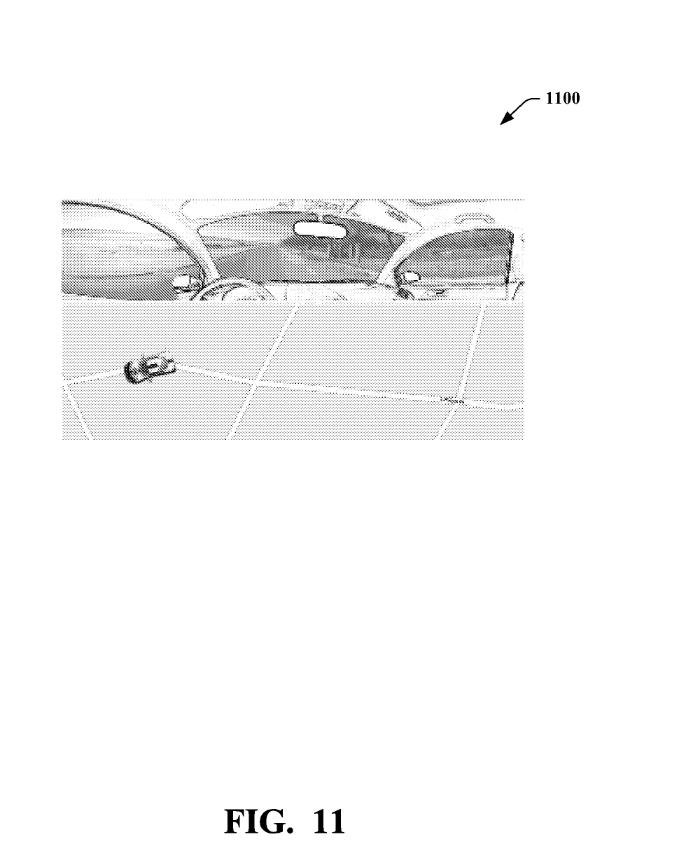

FIG. 11 illustrates a screen shot 1100 of a user interface that facilitates providing a panoramic view based at least in part on a ground-level orientation paradigm. The screen shot 1100 illustrates the employment of a 360 degree panoramic image. By utilizing a panoramic image, the view seen behind the designated skin (e.g., in this case the vehicle skin) is part of the panorama viewed from a particular angle. It is to be appreciated that this view can be snapped to 90 degrees based on the intuitive nature of the four major directions. The screen shot 1100 depicts a panoramic image taken by an omni-view camera seen employing the ground-level orientation paradigm, and in particular, the car paradigm.

Referring back to FIG. 7, specific details associated with the immersed view associated with the screen shot 700 are described. The orientation icon, or in this case, the car icon can facilitate moving/rotating the location associated with the aerial data. The car icon can represent the user's viewing location on the map (e.g., aerial data). The icon can be represented, for instance, as a car with the nose of the car pointing towards the location on the map which is displayed in the center view. The car can be controlled by an input device such as, but not limited to a mouse, wherein the mouse can control the car in two ways-dragging to change location and rotation to change viewing angle. When mouse cursor is on the car, the pointer changes to a “move” cursor (e.g., a cross of double-ended arrows) to indicate the user can drag the car. When the mouse cursor is near the edge of the car or on the headlight, it changes to a rotate cursor to indicate that the user can rotate the car (e.g., a pair of arrows directing in a circular direction). When the user is dragging or rotating the car, the view in the mock car windshield can update in real-time. This provides the user with a “video like” experience as the pictures rapidly change and display a view of moving down or along the side of the road.

Another option for setting the car orientation can be employed such as using direct gesture. Direct gesture can be utilized by clicking on the car, and dragging the mouse while holding the mouse button. The dragging gestures can define a view direction from the car position, and the car orientation is set to face that direction. Such interface is suited for viewing specific targets. The user can click on the car and drag towards the wished target in the top view. The result is an image in the front view that shows the target.

Another technique that can be implemented by the immersed view is a direct manipulation in the car display. The view in the car display can be dragged. A drag to the left will rotate the car in a clock-wise direction while a drag in the opposite direction will turn the car in a counter-clockwise direction. This control is, in particular, attractive when the images displayed through the car windows are a full 360 degrees or cylindrical or spherical panorama. Moreover, it can also be applicable for separate images such as described herein. Another example is dragging along the vertical axis to tilt the view angle and scan a higher image or even an image that spans the hemisphere around the car.

As discussed above, a snapping feature and/or technique can be employed to facilitate browsing aerial data and/or first-person perspective street-side imagery. It is to be appreciated that the snapping feature can be employed to an area that includes imagery data and areas with no imagery data. The car cursor can be used to tour the area and view the street-level imagery. For instance, important images such as those that are oriented in front of a house or other important land mark can be explored. Thus, users can prefer to see an image that captures most of a house, or that a house is centered in the image, rather than images that shows only parts of a house. By snapping the car cursor to points that best views houses on the street, we enable fast and efficient browsing of the images. The snapping can be generated given information regarding the houses foot print, or by detecting approximate foot print of the houses directly from the images (e.g. both the top view and the street-side images). Once the car is snapped to the house while dragging, or fast driving, a correction to the car position can be generated by keys input or slow dragging with the mouse. It is to be appreciated that the snapping feature can be employed in 2-D and/or 3-D space. In other words, the snapping feature can enforce the car to move along only the road geometry in both X, Y and Z dimensions for the purpose of showing street side imagery or video. The interface design is suitable for any media delivery mechanism. It is to be appreciated that the claimed subject matter is applicable to all forms of still imagery, stitched imagery, mosaic imagery, video, and/or 360 degree video.

Moreover, the street side concept directly enables various driving direction scenarios. For example, the subject claims can allow a route to be described with an interconnection of roads and automatically “play” the trip from start to end, displaying the street side media in succession simulating the trip from start point to end point along the designated route. It is to be understood that such aerial data and/or first-person and/or third-person street-side imagery can be in 2-D and/or 3-D. In general, it is to be appreciated that the aerial data need not be aerial data, but any suitable data related to a map.

In accordance with another aspect of the subject innovation, the user interface can detect at least one image associated with a particular aerial location. For instance, a bounding box can be defined around the orientation icon (e.g., the car icon), then a meta-database of imagery points can be checked to find the closest image in that box. The box can be defined to be large enough to allow the user to have a buffer zone around the road so the car (e.g., orientation icon) does not have to be exactly on the road to bring up imagery.

Furthermore, the subject innovation can include a driving game-like experience through keyboard control. For example, a user can control the orientation icon (e.g., the car icon) using the arrow keys on a keyboard. The up arrow can indicate a “forward” movement panning the map in the opposite direction that the car (e.g., icon) is facing. The down arrow can indicate a backwards movement and pans the map in the same direction that the car is facing move the car “backwards” on the map. The left and right arrow keys default to rotating the car to the left or right. The amount of rotation at each key press, could be set from 90 degrees jumps to very fine angle (e.g. to simulate a smooth rotation). In one example, the shift key can be depressed to allow a user can “strafe” left or right or move sideways. If the house-snapping feature is used, then a special strafe could be used to scroll to the next house along the road.

Furthermore, the snapping ability (e.g., feature and/or technique) allows the ability for the car (e.g., orientation icon) to “follow” the road. This is done by ascertaining the angle of the road at each point with imagery, then automatically rotating the car to a line with that angle. When a user moves forward the icon can land on the next point on the road and the process continues, providing a “stick to the road” experience even when the road curves.

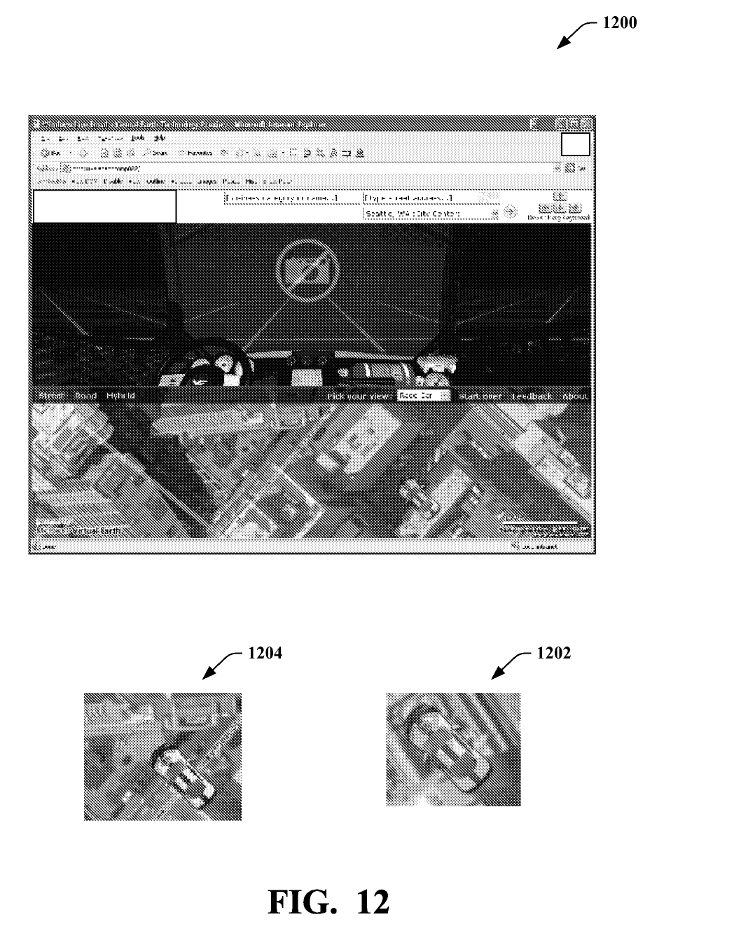

FIG. 12 illustrates a user interface 1200 that facilitates providing geographic data while indicating particular first-person street-side data is unavailable. The user interface 1200 is a screen shot that can inform that particular street-side imagery is not available. In particular, the second portion of the immersed view may not have any first-person perspective imagery that corresponds to the aerial data in the first portion. Thus, the second portion can display a image unavailable identifier. For example, a user can be informed if imagery is available. Feedback can be provided to the user in two unique manners. The first is through the use of “headlights” and transparency of the car icon. If imagery is present the car is fully opaque and the headlights are “turned on” and imagery is presented to the user in the mock car windshield as illustrated by a lighted orientation icon 1202. If no imagery is present the car turns semi-transparent and the headlights turn off, and a “no imagery” image is displayed to the user in the mock car windshield as illustrated by a “headlights off” orientation icon 1204. In a disparate example, the aerial data can be identified. For instance, streets can be marked and/or identified such that where imagery exist a particular color and/or pattern can be employed.

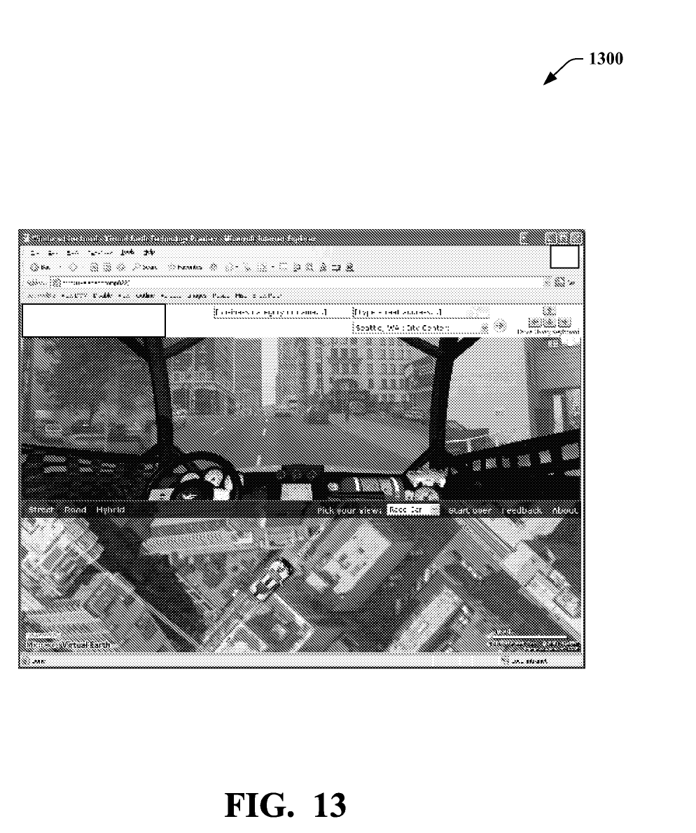

FIG. 13 illustrates a user interface 1300 that facilitates providing a particular orientation icon for presenting aerial data and a first-person street-side view. As discussed supra, the orientation icon and respective skin can be any display icon and respective skin such as, but not limited to, an automobile, a bicycle, a person, a graphic, an arrow, an all-terrain vehicle, a motorcycle, a van, a truck, a boat, a ship, a space ship, a bus, a plane, a jet, a unicycle, a skateboard, a scooter, a self-balancing human transporter, a hang-glider, and any suitable orientation icon that can provide a direction and/or orientation associated with aerial data. FIG. 13 illustrates the user interface 1300 that utilizes a vehicle icon as the orientation icon.

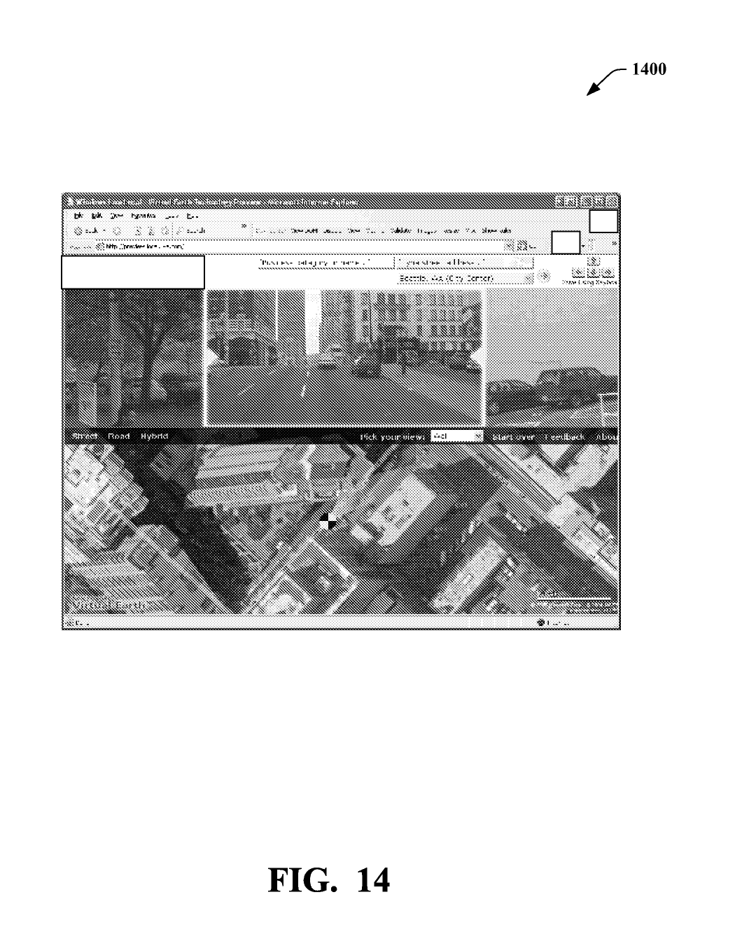

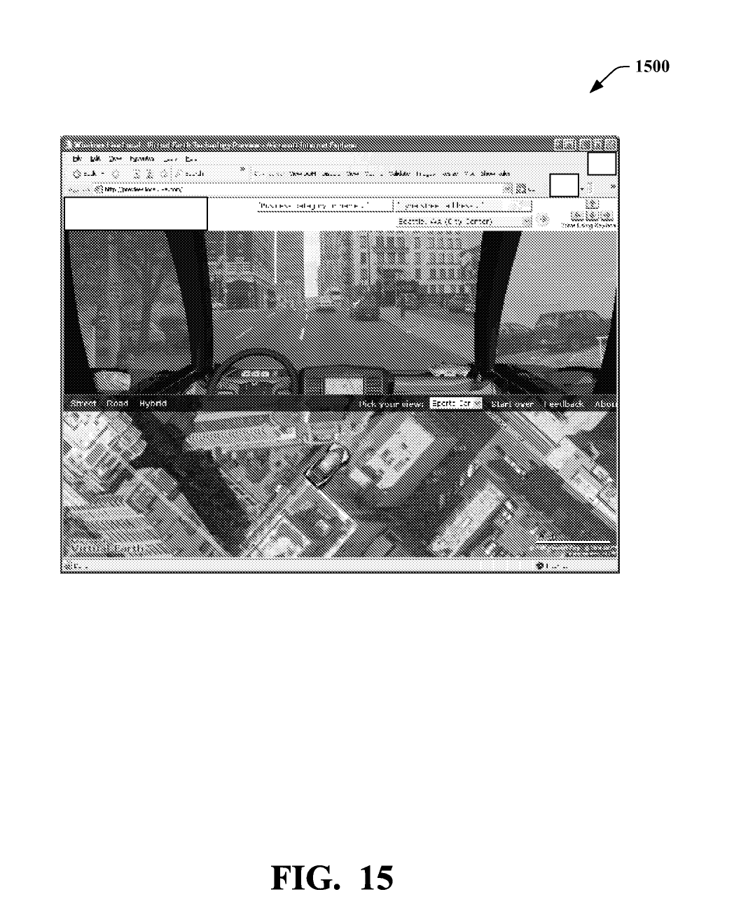

Turning briefly to FIG. 14, a user interface 1400 that facilitates providing a particular orientation icon for presenting aerial data and a first-person street-side view can be implemented. The icon in user interface 1400 is a graphic to depict a person walking with a particular skin. Turning to FIG. 15, a user interface 1500 that facilitates providing a particular orientation icon for presenting aerial data and a first-person street-side view can be employed. The user interface 1500 utilizes a sports car as an orientation icon with a sports car interior skin to view first-person street-side imagery.

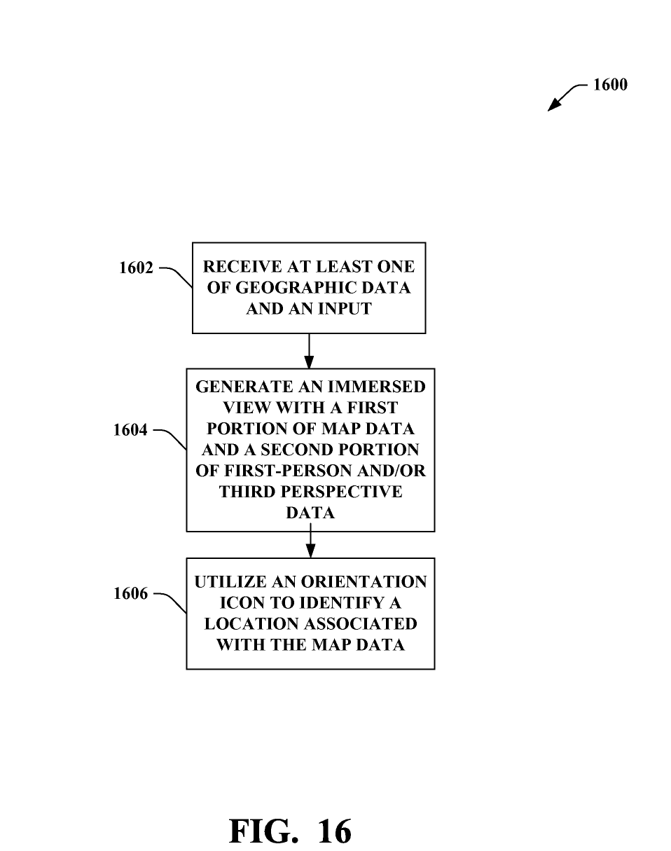

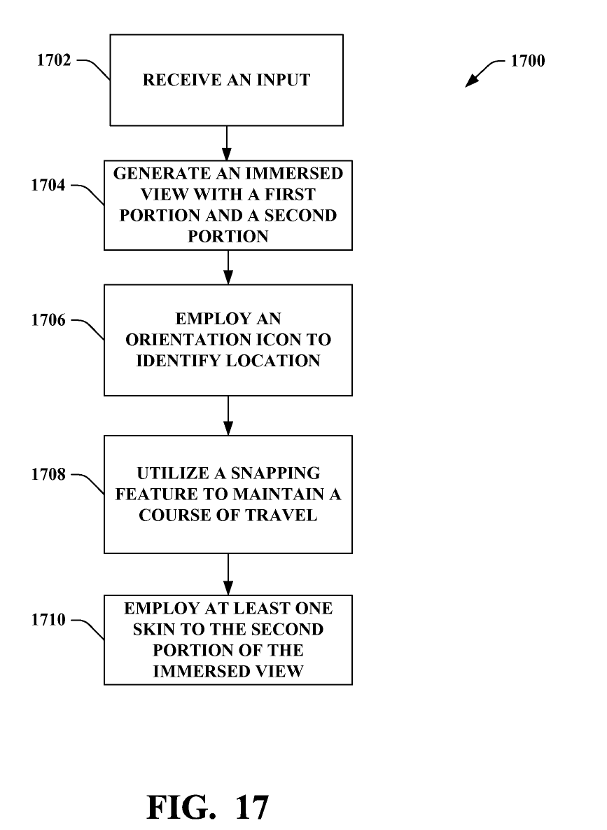

FIGS. 16-17 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 16 illustrates a methodology 1600 for providing an immerse view having at least one portion related to aerial view data and a disparate portion related to a first-person street-side view. At reference numeral 1602, at least one of geographic data and an input can be received. It is to be appreciated that the data can be any suitable geographic data such as, but not limited to, 2-dimensional geographic data, 3-dimensional geographic data, aerial data, street-side imagery (e.g. first-person perspective and/or third-person perspective), video associated with geography, video data, ground-level imagery, planetary data, planetary ground-level imagery, satellite data, digital data, images related to a geographic location, orthographic map data, scenery data, map data, street map data, hybrid data related to geography data (e.g., road data and/or aerial imagery), and any suitable data related to maps, geography, and/or outer space. In addition, it is to be appreciated that any input associated with a user, machine, computer, processor, and the like can be received. For example, the input can be, but is not limited to being, a starting address, a starting point, a location, an address, a zip code, a state, a country, a county, a landmark, a building, an intersection, a business, a longitude, a latitude, a global positioning (GPS) coordinate, a user input (e.g., a mouse click, an input device signal, a touch-screen input, a keyboard input, etc.), and any suitable data related to a location and/or point on a map of any area (e.g., land, water, outer space, air, solar systems, etc.). Moreover, it is to be appreciated that the input and/or geographic data can be a default setting and/or default data pre-established upon startup.

At reference numeral 1604, an immersed view with a first portion of map data (e.g., aerial data and/or any suitable data related to a map) and a second portion of first-person and/or third-person perspective data can be generated. The immersed view can provide an efficient and intuitive interface for the implementation of presenting map data and first-person and/or third-person perspective imagery. Thus, the second portion of the immersed view corresponds to a location identified on the map data. In addition, it is to be appreciated that the second portion of first-person and/or third-person perspective data can be partitioned into any suitable number of sections, wherein each section corresponds to a particular direction on the map data. Furthermore, the first portion and the second portion of the immersed view can be dynamically updated in real-time to provide exploration and navigation within the map data (e.g., aerial data and/or any suitable data related to a map) and the first-person and/or third-person imagery in a video-like experience.

At reference numeral 1606, an orientation icon can be utilized to identify a location associated with the map data (e.g. aerial). The orientation icon can be utilized to designate a location related to the map data (e.g., aerial map, aerial data, any data related to a map, normal rendered map, a 2-D map, etc.), where such orientation icon can be the basis of providing the perspective for the first-person and/or third-person view. In other words, an orientation icon can be pointing in the north direction on the aerial data, while the first-person and/or third-person view can be a ground-level, first-person and/or third-person perspective view of street-side imagery looking in the north direction. The orientation icon can be any suitable display icon such as, but not limited to, an automobile, a bicycle, a person, a graphic, an arrow, an all-terrain vehicle, a motorcycle, a van, a truck, a boat, a ship, a space ship, a bus, a plane, a jet, a unicycle, a skateboard, a scooter, a self-balancing human transporter, and any suitable orientation icon that can provide a direction and/or orientation associated with map data.

FIG. 17 illustrates a methodology 1700 for implementing an immerse view of geographic data having a first portion related to aerial data and a second portion related to a first-person street-side view based on a ground-level orientation paradigm. At reference numeral 1702, an input can be received. For example, the input can be, but is not limited to being, a starting address, a starting point, a location, an address, a zip code, a state, a country, a county, a landmark, a building, an intersection, a business, a longitude, a latitude, a global positioning (GPS) coordinate, a user input (e.g., a mouse click, an input device signal, a touch-screen input, a keyboard input, etc.), and any suitable data related to a location and/or point on a map of any area (e.g., land, water, outer space, air, solar systems, etc.). Moreover, it is to be appreciated that the input can be a default setting pre-established upon startup.

At reference numeral 1704, an immersed view including a first portion and a second portion can be generated. The first portion of the immersed view can include aerial data, while the second portion can include a first-person perspective based on a particular location associated with the aerial data. In addition, it is to be appreciated that the second portion can include any suitable number of sections that depict a first-person perspective in a specific direction on the aerial data. At reference numeral 1706, an orientation icon can be employed to identify a location on the aerial data. The orientation icon can identify a particular location associated with the aerial data and also allow movement to update/change the area on the aerial data and the first-person perspective view. As indicated above, the orientation icon can be any graphic and/or icon that indicates at least one direction and a location associated with the aerial data.

At reference numeral 1708, a snapping ability (e.g. feature and/or technique) can be utilized to maintain a course of travel. By employing the snapping ability, regardless of the input for a location, the orientation icon can maintain a course on a road, highway, street, path, etc. while still providing first-person ground-level imagery based on such snapped/designated course of the orientation icon. For instance, the orientation icon can be snapped and/or designated to follow a particular course of directions such that regardless of input, the orientation will only follow designated roads, paths, streets, highways, and the like. In other words, the snapping ability can be employed to facilitate browsing aerial data and/or first-person perspective street-side imagery.

At reference numeral 1710, at least one skin can be employed to the second portion of the immersed view. The skin can provide an interior appearance wrapped around at least the portion of the immersed view, wherein the skin corresponds to at least an interior aspect of the representative orientation icon. For example, when the orientation icon is a car icon, the skin can be a graphical representation of the inside of a car (e.g., steering wheel, gauges, dashboard, etc.). For example, the skin can be at least one of the following: an automobile interior skin; a sports car interior skin; a motorcycle first-person perspective skin; a person-perspective skin; a bicycle first-person perspective skin; a van interior skin; a truck interior skin; a boat interior skin; a submarine interior skin; a space ship interior skin; a bus interior skin; a plane interior skin; a jet interior skin; a unicycle first-person perspective skin; a skateboard first-person perspective skin; a scooter first-person perspective skin; and a self-balancing human transporter first perspective skin.

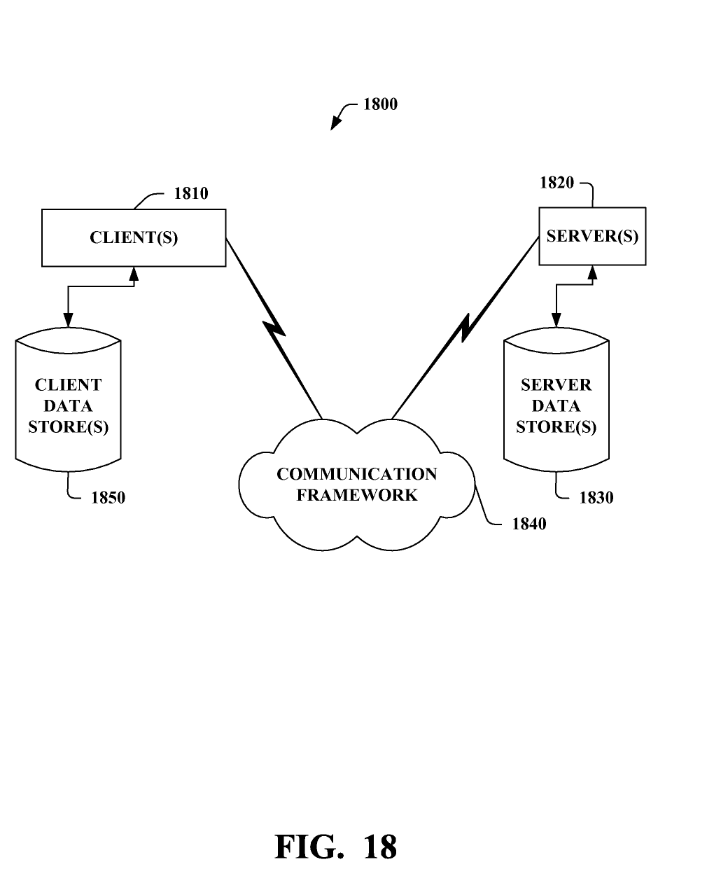

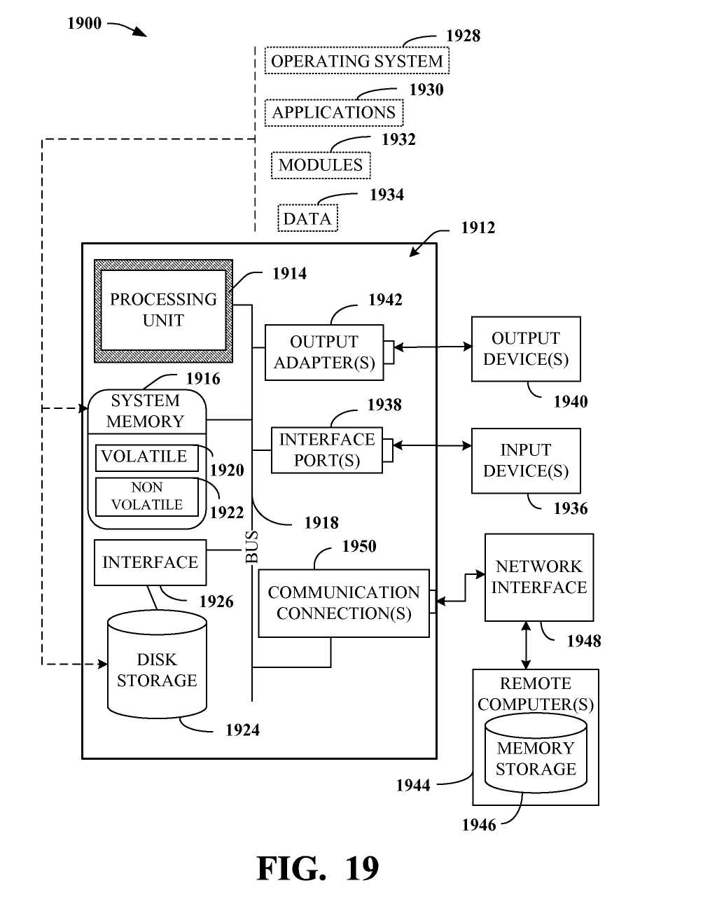

In order to provide additional context for implementing various aspects of the claimed subject matter, FIGS. 18-19 and the following discussion is intended to provide a brief, general description of a suitable computing environment in which the various aspects of the subject innovation may be implemented. For example, an interface component that can provide aerial data with at least a portion of a first-person street-side data, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 18 is a schematic block diagram of a sample-computing environment 1800 with which the claimed subject matter can interact. The system 1800 includes one or more client(s) 1810. The client(s) 1810 can be hardware and/or software (e.g., threads, processes, computing devices). The system 1800 also includes one or more server(s) 1820. The server(s) 1820 can be hardware and/or software (e.g., threads, processes, computing devices). The servers 1820 can house threads to perform transformations by employing the subject innovation, for example.

One possible communication between a client 1810 and a server 1820 can be in the form of a data packet adapted to be transmitted between two or more computer processes. The system 1800 includes a communication framework 1840 that can be employed to facilitate communications between the client(s) 1810 and the server(s) 1820. The client(s) 1810 are operably connected to one or more client data store(s) 1850 that can be employed to store information local to the client(s) 1810. Similarly, the server(s) 1820 are operably connected to one or more server data store(s) 1830 that can be employed to store information local to the servers 1820.

With reference to FIG. 19, an exemplary environment 1900 for implementing various aspects of the claimed subject matter includes a computer 1912. The computer 1912 includes a processing unit 1914, a system memory 1916, and a system bus 1918. The system bus 1918 couples system components including, but not limited to, the system memory 1916 to the processing unit 1914. The processing unit 1914 can be any of various available processors. Dual microprocessors and other multiprocessor architectures also can be employed as the processing unit 1914.

The system bus 1918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1916 includes volatile memory 1920 and nonvolatile memory 1922. The basic input/output system (BIOS), containing the basic routines to transfer information between elements within the computer 1912, such as during start-up, is stored in nonvolatile memory 1922. By way of illustration, and not limitation, nonvolatile memory 1922 can include read only memory (ROM), programmable ROM (PROM), electrically programmable ROM (EPROM), electrically erasable programmable ROM (EEPROM), or flash memory. Volatile memory 1920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1912 also includes removable/non-removable, volatile/non-volatile computer storage media. FIG. 19 illustrates, for example a disk storage 1924. Disk storage 1924 includes, but is not limited to, devices like a magnetic disk drive, floppy disk drive, tape drive, Jaz drive, Zip drive, LS-100 drive, flash memory card, or memory stick. In addition, disk storage 1924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1924 to the system bus 1918, a removable or non-removable interface is typically used such as interface 1926.

It is to be appreciated that FIG. 19 describes software that acts as an intermediary between users and the basic computer resources described in the suitable operating environment 1900. Such software includes an operating system 1928. Operating system 1928, which can be stored on disk storage 1924, acts to control and allocate resources of the computer system 1912. System applications 1930 take advantage of the management of resources by operating system 1928 through program modules 1932 and program data 1934 stored either in system memory 1916 or on disk storage 1924. It is to be appreciated that the claimed subject matter can be implemented with various operating systems or combinations of operating systems.

A user enters commands or information into the computer 1912 through input device(s) 1936. Input devices 1936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1914 through the system bus 1918 via interface port(s) 1938. Interface port(s) 1938 include, for example, a serial port, a parallel port, a game port, and a universal serial bus (USB). Output device(s) 1940 use some of the same type of ports as input device(s) 1936. Thus, for example, a USB port may be used to provide input to computer 1912, and to output information from computer 1912 to an output device 1940. Output adapter 1942 is provided to illustrate that there are some output devices 1940 like monitors, speakers, and printers, among other output devices 1940, which require special adapters. The output adapters 1942 include, by way of illustration and not limitation, video and sound cards that provide a means of connection between the output device 1940 and the system bus 1918. It should be noted that other devices and/or systems of devices provide both input and output capabilities such as remote computer(s) 1944.

Computer 1912 can operate in a networked environment using logical connections to one or more remote computers, such as remote computer(s) 1944. The remote computer(s) 1944 can be a personal computer, a server, a router, a network PC, a workstation, a microprocessor based appliance, a peer device or other common network node and the like, and typically includes many or all of the elements described relative to computer 1912. For purposes of brevity, only a memory storage device 1946 is illustrated with remote computer(s) 1944. Remote computer(s) 1944 is logically connected to computer 1912 through a network interface 1948 and then physically connected via communication connection 1950. Network interface 1948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1950 refers to the hardware/software employed to connect the network interface 1948 to the bus 1918. While communication connection 1950 is shown for illustrative clarity inside computer 1912, it can also be external to computer 1912. The hardware/software necessary for connection to the network interface 1948 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates providing geographic data, comprising:
a receiver component that receives at least one of geographic data and an input; and
an interface component that generates an immersed view based on at least one of the geographic data and the input, the immersed view includes a first portion of aerial data and a second portion of at least one of a first-person perspective view and a third-person perspective view corresponding to a location related to the aerial data.

2. The system of claim 1, the geographic data is at least one of 2-dimensional geographic data, 3-dimensional geographic data, aerial data, street-side imagery, a first-person perspective imagery data, a third-person perspective imagery data, video associated with geography, video data, ground-level imagery, planetary data, planetary ground-level imagery, satellite data, digital data, images related to a geographic location, orthographic map data, scenery data, map data, street map data, hybrid data related to geography data, road data, aerial imagery, and data related to at least one of a map, geography, and outer space.

3. The system of claim 1, the input is at least one of a starting address, a starting point, a location, an address, a zip code, a state, a country, a county, a landmark, a building, an intersection, a business, a longitude, a latitude, a global positioning (GPS) coordinate, a user input, a mouse click, an input device signal, a touch-screen input, a keyboard input, a location related to land, a location related to water, a location related to underwater, a location related to outer space, a location related to a solar system, and a location related to an airspace.

4. The system of claim 1, the first portion further comprising an orientation icon that can indicate the location and direction related to the aerial data.

5. The system of claim 4, the orientation icon is at least one of an automobile, a bicycle, a person, a graphic, an arrow, an all-terrain vehicle, a motorcycle, a van, a truck, a boat, a ship, a submarine, a space ship, a bus, a plane, a jet, a unicycle, a skateboard, a scooter, a self-balancing human transporter, and an icon that provides a direction associated with the aerial data.

6. The system of claim 4, the second portion of the at least one of the first-person perspective view and the third-person perspective view includes at least one of the following:
a first section illustrating at least one of a first-person perspective view and a third-person perspective view based on a center direction indicated by the orientation icon on the aerial data;
a second section illustrating at least one of a first-person perspective view and a third-person perspective view based on a left direction indicated by the orientation icon on the aerial data; and
a third section illustrating at least one of a first-person perspective view and a third-person perspective view based on a right direction indicated by the orientation icon on the aerial data.

7. The system of claim 6, further comprising a skin that provides an interior appearance wrapped around at least one of the first section, the second section, and the third section of the second portion, the skin corresponds to at least an interior aspect of the representative orientation icon.

8. The system of claim 7, the skin is at least one of the following: an automobile interior skin; a sports car interior skin; a motorcycle first-person perspective skin; a person-perspective skin; a bicycle first-person perspective skin; a van interior skin; a truck interior skin; a boat interior skin; a submarine interior skin; a space ship interior skin; a bus interior skin; a plane interior skin; a jet interior skin; a unicycle first-person perspective skin; a skateboard first-person perspective skin; a scooter first-person perspective skin; and a self-balancing human transporter first perspective skin.

9. The system of claim 1, the interface component allows at least one of a display of the immersed view and an interaction with the immersed view.

10. The system of claim 1, further comprising an application programmable interface (API) that can format the immersed view for implementation on an entity.

11. The system of claim 10, the entity is at least one of a device, a PC, a pocket PC, a tablet PC, a website, the Internet, a mobile communications device, a smartphone, a portable digital assistant (PDA), a hard disk, an email, a document, a component, a portion of software, an application, a server, a network, a TV, a monitor, a laptop, and a device capable of interacting with data.

12. The system of claim 1, at least one of the orientation icon and the at least one of the first-person perspective view and the third-person perspective view is based upon at least one of the following paradigms: a car paradigm; a vehicle paradigm; a transporting device paradigm; a ground-level paradigm; a sea-level; a planet-level paradigm; an ocean floor-level paradigm; a designated height in the air paradigm; a designated height off the ground paradigm; and a particular coordinate paradigm.

13. The system of claim 1, the first portion and the second portion of the immersed view are dynamically updated in real-time based upon the location of an orientation icon overlaying the aerial data giving a video-like experience.

14. The system of claim 1, the second portion of the at least one of first-person perspective view and third-person perspective view includes a plurality of sections illustrating a respective first-person view based on a particular direction indicated by an orientation icon within the aerial data.

15. The system of claim 1, further comprising a snapping ability that allows one of the following:
an orientation icon to maintain a pre-established course in a dimension of space;
an orientation icon to maintain a pre-established course upon the aerial data during a movement of the orientation icon; and
an orientation icon to maintain a pre-established view associated with a location on the map to ensure optimal view of such location during a movement of the orientation icon.

16. The system of claim 1, further comprising an indication within the immersed view that first-person perspective view imagery is unavailable by employing at least one of the following:
an orientation icon that becomes semi-transparent to indicate imagery is unavailable; and
an orientation icon that includes headlights, the headlights turn off to indicate imagery is unavailable.

17. The system of claim 1, the immersed view further comprising a direct gesture that allows a selection and a dragging movement of the orientation icon on the aerial data such that the second portion illustrates a view that mirrors the direction of the dragging movement to enhance location targeting.

18. A computer-implemented method that facilitates providing geographic data, comprising:
receiving at least one of geographic data and an input;
generating an immersed view with a first portion of map data and a second portion with at least one of first-person perspective data and third-person perspective data; and
utilizing an orientation icon to identify a location on the aerial data to allow the second portion to display at least one of a first-person perspective data and a third-person data that corresponds to such location.

19. The method of claim 18, further comprising:
utilizing a snapping feature to maintain a course of navigation associated with the aerial data; and
employing at least one skin with the second portion, the skin correlates to the orientation icon to simulate at least one of an interior perspective in context of the orientation icon.

20. A computer-implemented system that facilitates providing an immersed view to display geographic data, comprising:
means for receiving at least one of geographic data and an input;
means for generating an immersed view based on at least one of the geographic data and the input; and
means for including a first portion of aerial data and a second portion of a first-person perspective view corresponding to a location related to the aerial data within the immersed view.
